(19) United States
(12) Patent Application Publication
(10) Pub. No.: US 2006/0025304 A1
(43) Pub. Date: Feb. 2, 2006

(54) Radiation sensitive photocatalyst composition and application thereof

(76) Inventors: Chu-Fang Wang, Hsinchu City (TW); Ching-Tsung Yu, Bade City (TW); Jeng-Hung Lee, Longtan Township (TW)

Correspondence Address: SUPREME PATENT SERVICES, P.O. BOX 2339, SARATOGA, CA, 95070-0339, US

(21) Appl. No.: 11/145,419

(22) Filed: Jun. 3, 2005

(30) Foreign Application Priority Data
Jul. 27, 2004 (TW) 093122415

(51) Int. Cl. B01J 37/34; B01J 23/00

(52) U.S. Cl. 502/351; 502/5

(57) ABSTRACT

Disclosed is a radiation sensitive photocatalyst composition and application thereof. The composition can be induced by using ionization radiation or non-ionization radiation, which comprises a photocatalyst to perform photocatalysis; an enhancer to convert radiation energy into photons for photocatalysis; and a porous material to absorb and to immobilize the photocatalyst/enhancer becoming a composition system. The advantages of using radiation to carry out the photocatalytic reaction for environmental protection are high permeability as well as time flexibility in comparison of artificially UV/natural solar radiation. Anyway, the present invention can be used to fulfill the environmental application such as volume-reduction of spent radioactive resin and organics degradation. It is worthy to explore the regeneration of hydrogen energy by this invention.

### BACKGROUND OF THE INVENTION

1. Field of the Invention

The present invention relates to a radiation sensitive photocatalyst composition using radiation energy as energy source, and especially to its production and application method.

2. The Prior Arts

Photocatalyst has become one of the environmental clean-up materials. There are many materials on photocatalyst, such as titanium dioxide (TiO₂), ZnO, SnO₂, ZrO₂ oxides and CdS, ZnS sulfides. Among them, the most representative and most applied material is titanium dioxide due to its higher thermal stability in the atmosphere, non-toxic nature, low price, easy fabrication, and good physical-chemical behavior.

TiO₂-based nanocomposites are of considerable interest in environmental protection technology for applications as photocatalytic materials. It is effective to treat many pollutants, such as benzene chlorides, phenol chlorides compounds, cyanides, and metal ions. Moreover, the synergistic effect to combine adsorbent and TiO₂-based photocatalyst is very interesting in environmental protection technology. Photocatalyst plays a role of catalyst, which can easily be reduced in photocatalytic regeneration. Therefore, the development and application of photocatalysts are under extensive study and become one of the most potential targets. Since the discovery of TiO₂ in 1972, it has been broadly applied in industry of paints, masks, household appliances, and fabrics.

Titanium dioxide is a metal oxide semiconductor, and it has been proven effective in UV/Vis radiation. TiO₂ will be activated under solar or ultraviolet irradiation to form carriers of electrons (e⁻) and electric holes (h⁺) promoting oxidation-reduction reactions on the surface. Holes on the surface of titanium atom oxidize the adsorbed water molecule to form powerful oxidizer of hydroxyl radicals (.OH). It is promising to study the photo-degradation and mineralization of environmental pollutants by using TiO₂-based photocatalyst.

TiO₂ is also a material that possesses a direct band-gap (3.2 eV at room temperature). Many researchers reported that titania particles loaded with Pt, Ag, Fe, ZnO and CdS show improved photoactivity in the visible range. Some multicomponents or mixed oxides such as SrTiO₃, BaTiO₃, titania/zirconia, K₂La₂TiO₃, and silica-titania also have good photoactivity. However, weak penetration ability and low light source intensity that has limited their applications in many industrial or environmental fields.

For light amplification purposes, materials doped with transition metals or rare earth element in the form of fluorite crystals have been developed. Among these, BaF₂ has been considered as an intrinsic scintillation material with transparency in the visible and near IR regions, fast decay time (sub-nano sec), high density, and non-hygroscopic properties. Most of all, it has an excellent emission yield with photo-peaks at 220 and 310 nm after excited by higher radiation. It is expected that TiO₂ based photo-catalytic reactions can be significantly triggered using the y or other high-energy radiation because of the co-existence of scintillation crystals in the composite.

Not many references discussed using y radiation to induce the TiO₂ photocatalytic reaction. Seino et al. discussed phenol photo-degradation effects for TiO₂ and Al₂O₃ nanoparticle excited using y radiation. DOE explored the feasibility if ionization radiation used to catalytically destroy EDTA organics in the high level radwaste over semiconducting metal oxide particles. Both need a very high radiation dose to facilitate the experiment.

The major benefit of using γ radiation as an energy source is attributed to its deep penetrating ability into most materials. The existence of BaF₂ enhances the photoactivity of TiO₂ and becomes a light source around TiO₂ by converting the γ radiation. As a result, nanophase BaF₂/TiO₂ composites can be prepared on porous substrates, and applied in various industrial and environmental applications as a real three-dimensional technology.

### SUMMARY OF THE INVENTION

To solve the radiation penetration problem of traditional techniques in TiO₂-based photocatalytic reaction, and to improve the high-energy radiation efficiency in irradiated TiO₂. The inventors provide a synthesis method to prepare scintillator/TiO₂/adsorbent nanocomposite composition. It is hoped to combine synergistic effect and high-energy radiation to develop a three-dimensional photocatalytic technology. FIG. 1 shows the diagram of an example of TiO₂-based nanocomposition, wherein barium fluoride is used as a scintillator to enhance the efficiency of TiO₂ irradiated by ionization radiation. The multi-step photocatalytic reaction mechanism can be elecited as follow. The high-energy radiation is absorbed by the BaF₂ crystal to excite Ba core valence band electrons. The electron may jump into the conducting band area, travel around the crystal and gradually lose its energy. These electrons are finally relaxated and captured by florine ions. After that transition, a 220 nm or 315 nm UV light will be emitted and absorbed by the surrounding TiO₂ to further trigger photo-oxidation reaction. As a result, the technology is no longer considered two-dimensional surface technology only. It is expected to apply this technology to the treatment of environmental organics.

Therefore, one object of the present invention is to provide a novel photocatalyst composition that can be irradiated to carry out photocatalytic reaction by UV radiation and/or ionization radiation. To fulfill the objective of the present invention, the composition according to the invention comprises: a photocatalyst to perform photocatalysis reaction; an enhancer (scintillator) to absorb radiation energy and effectively to induce photocatalysis process; and a porous material as a substrate to absorb and to immobilize the photocatalyst as well as enhancer. The enhancer and photocatalyst in composition are preferred in the ratio of 1-40% (weight percentage) respectively.

Another object of the present invention is to provide a method for preparing a radiation sensitive photocatalyst composition. The method comprises the steps of: (i) synthesizing an enhancer and a photocatalyst, and (ii) absorbing and immobilizing the photocatalyst and the enhancer in a porous material; wherein the photocatalyst can be excited by defined photons to achieve photocatalysis, the enhancer can absorb radiation energy to excite photocatalyst to carry out photocatalysis, and the porous material can embed and immobilize the photocatalyst as well as enhancer to form a composition applied in photocatalysis.

Another object of the invention also provides a method for using radiation sensitive photocatalyst composition. The method comprises the steps of: (1) obtaining a radiation sensitive photocatalyst composition comprises a photocatalyst as well as an enhancer, (2) contacting the composition with a substance desired to treat, (3) making the enhancer to be irradiated, and (4) releasing desired UV radiation from the enhancer to promote the reduction-oxidation reaction between the photocatalyst and the organic.

The photocatalyst in the radiation-sensitive photocatalyst composition of the invention is not particularly restricted, but preferably to be titanium dioxide. The enhancer is also not limited, as long as it can absorb radiation energy and releases appropriate UV radiation energy to perform photocatalysis. Many inorganic scintillators emit light in defined wavelength after absorbing energy, which therefore are suitable to be the enhancers of the invention. To fulfill the purpose of the present invention, the scintillators with emitting light less than 380 nm after irradiation can be chosen for the composition. Table 1 lists the materials emitted light lower than 380 nm after absorbing radiation. It is preferred to choose barium fluoride as the enhancer for the consideration of the maximal emitted wavelength and the abundance of element.

It is worthy to consider the size of titanium dioxide and the enhancer to fulfill the requirement of photocatalytic reaction. The preferred sizes of titanium dioxide and the enhancer used in the present invention will be in the nano-scale. A preferred size for photocatalysts is less than 100 nm, and the dimension of enhancers may be lower than 500 nm.

The micron-sized porous material can be chosen as a support. The large surface area (at least higher than 50 m²/g) and pore volume of them can provide site to effectively absorb and immobilize photocatalyst as well as enhancer. It is expected that the heterogeneous photocatalytic efficiency will be greatly improved for the concentration of organics on composite surface. Some candidates such as glass powder, activated carbon, or ceramic powder are suitable substance. We thus proposed a synthesis method to co-deposit the enhancer (BaF₂)/photocatalyst (TiO₂) on the porous substrate and to avoid the nanoparticle aggregation tendency.

During synthesis, an EDTA chelating agent was chosen to functionally link the Ba compounds with the ceramic substrate using electrostatic attraction. Nano-size TiO₂ was formed by citric acid chelating in 0.5M HCl. The suspended solution of BaF₂, TiO₂ was mixed with porous substrate, the composition can be obtained after calcination at 400-600° C. The prepared product can be examined with various analytic methods using Scanning Electron Microscopy/Electron Dispersive X-ray Spectroscopy (SEM/EDX), Atomic Force Microscopy (AFM), X-ray Diffraction (XRD), X-ray Photoelectron Spectroscopy (XPS), Brunauer-Emmett-Teller (BET) and Inductively Coupled Plasma-Atomic Emission Spectrometry (ICP-AES) Analysis. Various ionization radiation (such as gamma, X-ray and alpha/beta particle) and non-ionization radiation (ultraviolet) sources can be applied to trigger photocatalytic reaction.

The present invention is further explained in the following illustrations and embodiments. What needs to be emphasized is that the present invention disclosed above is not limited by these examples. The present invention may be altered or modified by people skilled in the art and all such variations are within the scope and spirit of the present invention.

### BRIEF DESCRIPTION OF THE DRAWINGS

The related drawings in connection with the detailed description of the present invention to be made later are described briefly as follows, in which:

FIG. 1 shows the diagram of photocatalytic reaction induced by ionizing radiation using prepared composition proposed in the invention.

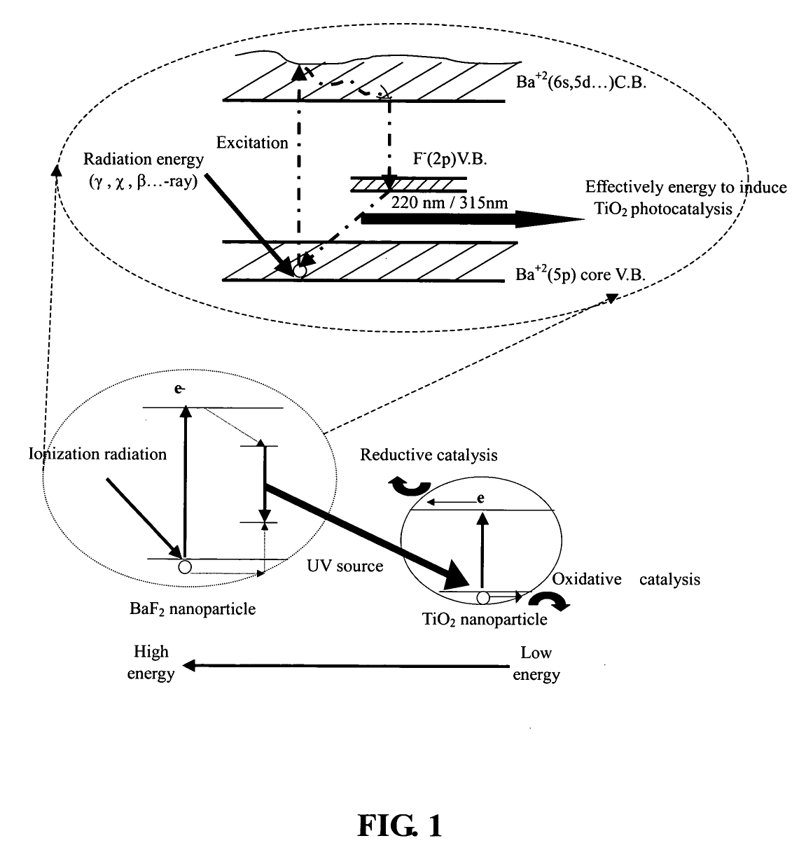

FIG. 2 shows the flow chart of preparing radiation sensitive photocatalyst composition proposed in the invention.

FIG. 3 (a) shows the image of photocatalyst composition observed with a Scanning Electron Microscope (magnification of 130k), (b) shows the spectrum of EDX analysis.

FIG. 4 shows the diagram of reaction setup for photocatalysis using photocatalyst composition proposed in the invention.

### DETAILED DESCRIPTION OF THE PREFERRED EMBODIMENT

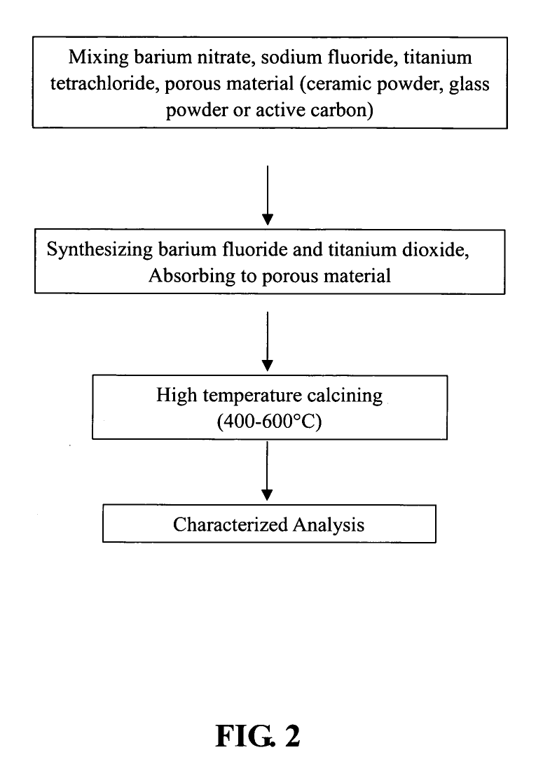

FIG. 2 shows the flow chart of preparing radiation sensitive photocatalyst composition. As shown in FIG. 2, barium nitrate, sodium fluoride, titanium tetrachloride and porous materials (such ceramic powder, glass powder or active carbon) are mixed to synthesize barium fluoride (enhancer) and titanium dioxide (photocatalyst) and immobilized them on porous materials. The radiation sensitive photocatalyst composition is obtained after calcination at 400-600° C. The product is examined with the following analytic methods: surface characteristics of physical properties indicated morphology, nanoparticle scale, and specific surface area were studied using SEM/EDX, AFM and BET respectively. XRD and XPS instrument observed nanocrystalline pattern and bonding state of chemical composition. Meanwhile, Ba/Ti concentration on nanocomposite was analyzed using acid mixture digestion an ICP-AES spectrometer.

The specific embodiments and preferred methods are described herein.

### EXAMPLE 1

### Preparation of Radiation Sensitive Photocatalyst Composition

A predetermined amount of EDTA is mixed into alkaline solution at room temperature, followed by addition and dissolution of barium nitrate, sodium fluoride. After ceramic powder is added and stirred evenly, titanium tetrachloride is slowly dropped into the solution and stirred for at least two hours. The mixture is heated to evaporate the solution, dried in an oven, and calcined at 400° C. to obtain the radiation sensitive photocatalyst composition powder. The weight of barium nitrate, sodium fluoride, titanium tetrachloride and porous materials are in the ratio of 1-5:0.7-1.8:0.4-2.0:2-7. The molal for EDTA is the sum of those of barium nitrate and titanium tetrachloride. Both barium fluoride and titanium dioxide are eventually synthesized and immobilized on the surface of porous ceramic powder.

The weight content of titanium and barium in the finished product of radiation sensitive photocatalyst composition is determined through acid mixture digestion and ICP analysis. Table 2 lists the contents of titanium and barium in six combinations of the various ratios among barium nitrate, sodium fluoride, titanium tetrachloride and porous materials. Titanium and barium are illuminated to be contained in these six compositions, and the amounts of these two elements will be increased with the increase of barium nitrate, sodium fluoride, and titanium tetrachloride.

The sample C6 of Table 2 is taken as an example. The SEM analysis exhibits that both the nanoparticles of BaF₂ and TiO₂ are immobilized on photocatalyst composition surface. For the XRD analysis, we choose pure carbon as substrate providing a clear base enable to study the characteristic of prepared composite. X-ray diffraction (XRD) scan is employed to analyze the texture of samples, which shows the 2θ peaks around 26.5° for graphite carbon in spectrum. The XRD data of anatase phase titanium dioxide shows peak at 2θ value of 25.2°. The 2θ peak values of barium fluoride are at 23.9°, 28.5°, 41.2°, 66.1°, 67.9°, which belongs to frankdicksonite minerals. When the product is characterized by X-ray photoelectron spectroscopy (XPS), the peaks locate at 458.7 eV, 530 eV, 780 eV, 795 eV, and 684 eV are assigned to Ti 2p, O ls, Ba⁺² (Ba 3d5/2 and Ba 3d3/2), F ls respectively. The AFM measurements showed the needle structure of around 6-10 nm nanoparticle appeared covering on the carbon surface. Therefore in the composition of the invention, the particles are in the range of nano scale size, and contain anatase phase of titanium dioxide and frankdicksonite minerals of barium fluoride.

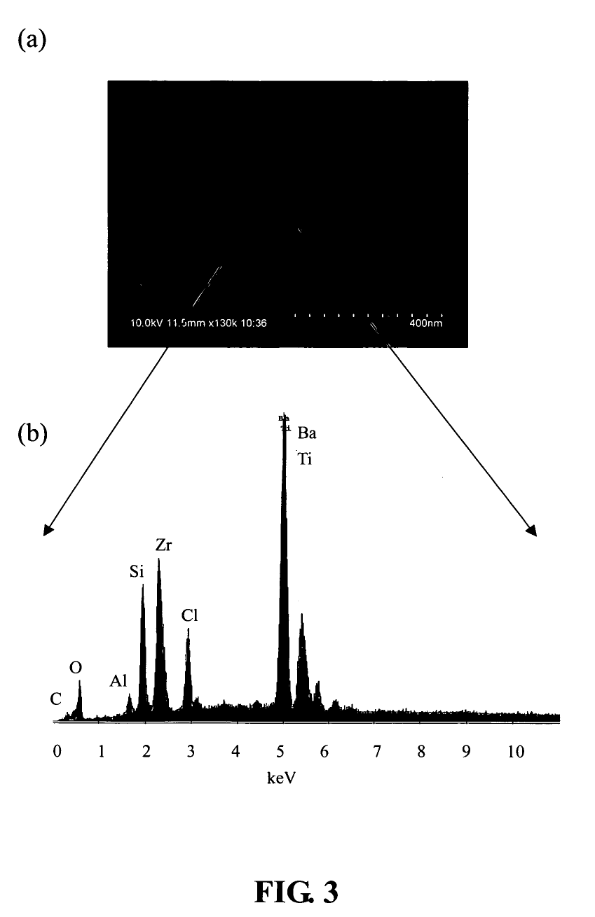

FIG. 3 shows the SEM image (magnification of 130k) and the EDX spectrum of radiation sensitive photocatalyst composition. The porous material used in the composition is ceramic powder. Cubic shape of crystalline of BaF₂ was observed with a mean size of about 300 nm. It was also found there exist finely grain TiO₂ particles with size less than 100 nm.

### EXAMPLE 2

### Photocatalysis with Radiation Sensitive Photocatalyst Composition by γ-Ray of Co-60 Radiation

Methylene blue (MB) is prepared at six aliquots of 10 ppm solution with 0.2 g of each C1-C6 photocatalysis composition prepared from Example 1 respectively. These slurries are irradiated with 5×10⁶ Bq Co-60 source at 0.3Gy (wherein the maximal absorption dose rate is 4 mGy/h). The maximal absorbance of MB peaks is at 663 nm. The degradation of MB during the experiment has been determined with the UV-Vis. spectrophotometer.

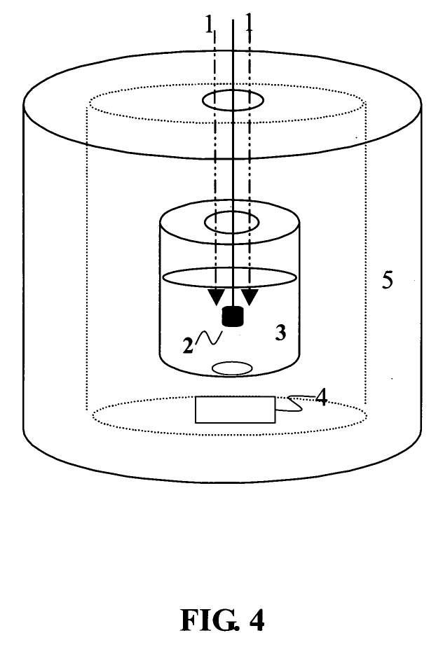

The diagram of reaction setup for photocatalysis using photocatalyst composition proposed in the invention is shown in FIG. 4. Organic substance desired to be treated (such as dyes, spent resin or industrial waste water) and the radiation sensitive photocatalyst composition are added into the solution and homogeneously mixed with a stirrer as mixture. Radiation source Co-60 is placed in the mixture with an outside lead shield protection. Fresh air is injected into the reactor.

As listed in Table 3, A₀ represents the measured absorbance activity of MB solution before the irradiation at wavelength 663 nm, and Aₜ represents the absorbance activity after the irradiation treatment for the composition. Therefore the lower the Aₜ/A₀ value (the MB photo-degradation ratio), the better catalytic ability of the photocatalyst. Table 3 further reveals that the irradiation of Co-60 can induce photocatalytic reduction of MB in all the composition of C₁-C₆, and all reactions reveal the color fading effects. In addition, groups C₄-C₆ with high titanium content showed better catalytic abilities than low titanium content groups C₁-C₃. And the higher barium content ensures better catalytic abilities in the groups with similar titanium contents.

### EXAMPLE 3

### Photocatalysis with Radiation Sensitive Photocatalyst Composition by β of P-32 Radiation

70 ml of 100 ppm phenol solution is prepared with 0.2 g C6 photocatalysis composition prepared from Example 1. The slurry is irradiated with 1.7×10⁷ Bq P-32 source for various period of time. The maximal absorbance of phenol peaks is at 270 nm. The degradation of phenol during the experiment has been determined with HPLC (PROSTAR-ANALYTICAL HPLC from VARIAN) equipped with Lichrospher 100 RP-18 Column (5 micron), and the mobile phase contains 50% of acetonitrile and 50% of distilled water.

The reactor setup for photocatalysis is shown as FIG. 4 except the Co-60 is replaced by P-32.

As listed in Table 4, AO represents the measured absorbance activity of phenol solution before the irradiation at wavelength 270 nm, and Aₜ represents the absorbance activity after the irradiation treatment for the composition. The Aₜ/A₀ value is decreased with the increased irradiation time. It shows that a P particle of irradiation source is available for photocatalysis with radiation sensitive photocatalyst composition of the present invention.

### EXAMPLE 4

### Radioactive Waste Treated with Radiation Sensitive Photocatalyst Composition

The substance desired to be treated is the cationic exchange resin from Purolite Corporation used by a typical nuclear power plant. Mixture (3) of 1 g of resin, 1 g of the radiation sensitive photocatalyst composition (prepared as in Example 1), 70 ml of water and Co-60 (2) are placed into a reactor with lead shielding (5) as shown in FIG. 4. The radioactive waste treatment is carried out with continuous stirring by stirrer (4) and air (1) flowing. The total organic carbon (TOC) levels are determined after the abovementioned solution is irradiated with various dosages. Table 5 shows the TOC data of photo-degradation for Purolite resin under different radiation doses. The granular resins initially dissociate to fine powder, and gradually dissolved into water with small molecules. The TOC level is decreased with increasing doses, it is observed that only 1% TOC left with 9Gy irradiation dose significantly. The degradation of spent resin can be accomplished using the invented photocatalyst under high-energy radiation. It is expected to fulfill the purpose of destructing spent resin and absolutely mineralizing the organics. It is advantage of simple preparing procedure, low cost and recycled for the synthesized composition.

The traditional photocatalyst has been limited to the surface-response photocatalytic reaction using UV radiation. In this invention, ultraviolet and ionization radiation can be used at the same time to increase the efficiency of the composition. The use of ionization radiation has the advantages of high permeability. It is noticeable that the application has the flexible benefits of time, location, as well as weather condition in comparison of naturally solar radiation. The present invention also can be used to fulfill the volume-reduction of spent resin. It is hopeful to explore the regeneration of hydrogen energy by this invention.

TABLE 1
The wavelength of maximum emission (nm) of some scintillators

| | Wavelength of |
|---|---|
| Scintillators | maximum emission (nm) |
| NaI | 303 |
| CsI | 310 |
| BaF₂ | 190/220; |
| | 310 |
| CeF₃ | 300; |
| | 340 |
| YAP | 370 |

TABLE 2
The ICP results of the radiation sensitive photocatalyst
compositions in the invention (N = 5)

| Compo- | | | | | |
|---|---|---|---|---|---|
| sition | Added amount | | | Concentration (mg/g) | |
| No. | TiCl₄ (g) | Ba(NO₃)₂ (g) | NaF (g) | Ti | Ba |
| C1 | 0.4 | 1.0 | 0.7 | 15.3 ± 1.5 | 43.2 ± 2.6 |
| C2 | 0.4 | 3.1 | 1.1 | 16.2 ± 1.6 | 105 ± 5 |
| C3 | 0.4 | 5.1 | 1.8 | 18.1 ± 1.4 | 156 ± 5 |
| C4 | 2.0 | 1.0 | 0.7 | 45.2 ± 2.5 | 38.1 ± 2.1 |
| C5 | 2.0 | 3.1 | 1.1 | 44.5 ± 2.6 | 102 ± 4 |
| C6 | 2.0 | 5.1 | 1.8 | 41.1 ± 2.3 | 140 ± 5 |

TABLE 3
Degradation of Methylene blue irradiated by Co-60 with the radiation
sensitive photocatalyst composition in the present invention

| Composition No. | Aₜ/Aₒ |
|---|---|
| C1 | 0.62 |
| C2 | 0.53 |
| C3 | 0.41 |
| C4 | 0.35 |
| C5 | 0.33 |
| C6 | 0.20 |

TABLE 4
Degradation of phenol irradiated by P-32 with the radiation
sensitive photocatalyst composition in the present invention

| Time (hours) | Aₜ/Aₒ |
|---|---|
| 0 | 1.00 |
| 24 | 0.55 |
| 48 | 0.19 |
| 72 | 0.05 |
| 96 | 0.01 |

TABLE 5
Reaction on cationic exchange resins irradiated
by Co-60 with the radiation sensitive photocatalyst
composition in the present invention

| Radiation dose (Gy) | TOC (ppm) |
|---|---|
| 0 | 336,000 |
| 1 | 3,480 |
| 3 | 2,660 |
| 5 | 2,140 |
| 9 | 2,050 |

What is claimed is:

1. A radiation sensitive photocatalyst composition, which uses radiation energy to be an exciting energy for photocatalysis, comprising:
a photocatalyst performing photocatalysis;
an enhancer absorbing radiation energy and emitting photons to excite the photocatalyst to perform photocatalytic reaction; and
a porous material for absorbing and immobilizing the photocatalyst and enhancer;
wherein the photocatalyst and enhancer is in a ratio of 1-50% (weight percentage).

2. The composition as claimed in claim 1, wherein the radiation is selected from the group consisting of ultraviolet, gamma, X-ray and alpha/beta particle.

3. The composition as claimed in claim 1, wherein the enhancer is an inorganic scintillator.

4. The composition as claimed in claim 1, wherein the enhancer is selected from the group consisting of NaI, CsI, BaF₂, CeF₃, and YAP.

5. The composition as claimed in claim 1, wherein the enhancer is barium fluoride.

6. The composition as claimed in claim 1, wherein the photocatalyst is titanium dioxide.

7. The composition as claimed in claim 1, wherein the porous material is selected from the group consisting of ceramic powder, glass powder, and active carbon.

8. The composition as claimed in claim 1, wherein the maximal particle sizes for photocatalyst and enhancer are 100 nm and 300 nm respectively.

9. The composition as claimed in claim 1, wherein the porous material is in micron-scale, and the specific surface area is at least 50 m²/g.

10. A method for preparing a radiation sensitive photocatalyst composition, comprising the steps of:
(i) synthesizing a photocatalyst and an enhancer;
(ii) absorbing and immobilizing the photocatalyst and the enhancer to a porous material;
wherein the radiation sensitive photocatalyst composition is excited by defined photons to catalyze photocatalysis, the enhancers absorbing radiation energy and releasing photons to excite photocatalyst to carry out photocatalysis, the porous material absorbing and immobilizing the photocatalyst and the enhancer.

11. The method as claimed in claim 10, wherein the photocatalyst is titanium dioxide.

12. The method as claimed in claim 10, wherein the enhancer is an inorganic scintillator.

13. The method as claimed in claim 10, wherein the enhancer is selected from the group consisting of NaI, CsI, BaF₂, CeF₃, and YAP.

14. The method as claimed in claim 10, wherein the enhancer is barium fluoride.

15. The method as claimed in claim 10, wherein the porous material is selected from the group consisting of ceramic powder, glass powder, and active carbon.

16. The method as claimed in claim 10, wherein step (i) comprises mixing powders comprising barium nitrate, sodium fluoride, titanium tetrachloride, linking agent and porous material and being reacted to synthesize barium fluoride.

17. The method as claimed in claim 16, wherein the linking agent is EDTA.

18. The method as claimed in claim 17, wherein the weight ratios of powders of barium nitrate, sodium fluoride, titanium tetrachloride and ceramic powder are 1-5:0.7-1.8:0.4-2.0:2-7, and the molal for EDTA is the sum of barium nitrate and titanium tetrachloride.

19. The method as claimed in claim 10, wherein step (ii) comprises a high temperature calcination process at 400-600° C.

20. A method for using the radiation sensitive photocatalyst composition, comprising the steps of:
(1) synthesizing a radiation sensitive photocatalyst composition as claimed in claim 1;
(2) contacting the composition with a substance desired to treat;
(3) making the enhancer of the composition expose to absorb radiation energy; and
(4) releasing photons from the enhancer to promote a reduction-oxidation between the photocatalyst of the composition and the substance desired to treat.

21. The method as claimed in claim 20, wherein the substance desired to treat comprises an azo dye.

22. The method as claimed in claim 20, wherein the substance desired to treat comprises industrial spent waste resin.

23. The method as claimed in claim 20, wherein the radiation energy is selected from the group consisting of ultraviolet light, gamma, X-ray and alpha/beta particle.

24. The method as claimed in claim 20, wherein the photocatalyst is titanium dioxide.

25. The method as claimed in claim 20, wherein the enhancer is an inorganic scintillator.

26. The method as claimed in claim 20, wherein the enhancer is selected from the group consisting of NaI, CsI, BaF₂, CeF₃, and YAP.

27. The method as claimed in claim 20, wherein the enhancer is barium fluoride.
